(19) United States
(12) Patent Application Publication
(10) Pub. No.: US 2026/0259770 A1
(43) Pub. Date: Sep. 3, 2026

(54) GPU COMPUTING RESOURCE MANAGEMENT METHOD AND APPARATUS, ELECTRONIC DEVICE AND READABLE STORAGE MEDIUM

(71) Applicant: SUZHOU METABRAIN INTELLIGENT TECHNOLOGY CO., LTD., Suzhou, Jiangsu (CN)

(72) Inventor: Chao WANG, Suzhou, Jiangsu (CN)

(21) Appl. No.: 18/871,456

(22) PCT Filed: Jul. 11, 2023
(86) PCT No.: PCT/CN2023/106827

§ 371 Date: Dec. 3, 2024

(30) Foreign Application Priority Data
Dec. 6, 2022 (CN) 202211553120.5

(51) Int. Cl. G06F 9/50; G06T 1/60

(52) U.S. Cl. CPC G06F 9/5027; G06T 1/60

(57) ABSTRACT

The embodiments of the present application provide a GPU computing resource management method and apparatus, an electronic device and a readable storage medium. The method comprises: dividing a GPU in a Node node to obtain multiple vGPUs, wherein, each vGPU comprises a part of a GPU video memory and a part of a GPU computing core of the GPU, and one vGPU corresponds to one Pod service; collecting vGPU information of each vGPU in the Node node, and registering the information of each vGPU to obtain Pod information of each Pod service corresponding to each vGPU; receiving each piece of Pod information and storing each piece of Pod information as multiple files; and managing the part of GPU video memory and the part of GPU computing core in each vGPU according to the files. By means of using the aforementioned method, the running of multiple Pod services on the same physical GPU can be supported while strictly isolating GPU computing resources.

### CROSS-REFERENCE TO RELATED APPLICATIONS

This application claims the priority of Chinese patent application filed in CNIPA on Dec. 6, 2022, with the application number of 202211553120.5 and the application name of “GPU computing resource management method and apparatus, electronic device and readable storage medium”, the entire contents of which are incorporated into this application by reference.

### TECHNICAL FIELD

The embodiments of the present disclosure relates to the technical field of the Internet, in particular to a GPU computing resource management method, a GPU computing resource management apparatus, an electronic device and a non-transitory readable storage medium.

### TECHNICAL BACKGROUND

GPU (Graphics Processing Unit), as a large-scale parallel computing architecture composed of a large number of cores, is designed to handle multiple tasks at the same time. As a leading computing engine in the artificial intelligence revolution, GPU has great advantages in large-scale parallel computing, which provides significant computing performance and accelerated support for scenarios such as big data, artificial intelligence training, inferencing tasks, and image rendering and etc.

For artificial intelligence developers, GPU-based AI system (research institutions) or new/traditional enterprises undergoing digital transformation, when using GPU computing resources, they are bound to face the following problems.
(1) Management of GPU resource is difficult. GPU is more expensive than CPU (central processing unit). As a high-value hardware resource, GPU is difficult to achieve the integrated mode of maintenance and management like network and storage. In a practical application environment, it often happens that multiple processes, multiple personnel and multiple tasks reuse the same GPU resources. Long waiting time for resources seriously contracts efficiency of business processes and speed of product iteration.
(2) The utilization efficiency of GPU resources is low. For AI (Artificial Intelligence) services (such as on-premise or cloud) that require less computing power, it is usually impossible to use a GPU card at full load, and users also need to distinguish different types of GPUs when using GPU resources to adapt to computing cores, drivers and other version components of GPUs of different architectures and models. These factors inevitably bring users a higher threshold for use.
(3) It is difficult to quickly apply for and recycle GPU resources. In a production environment, the application and release of GPU resources by AI services need to be automatically expanded and contracted according to the Query Per Second (QPS) based on a usage cycle of task load and a usage of GPU resources by different tasks at peak/trough, so as to meet the real-time high concurrency and low latency requirements of online AI services.

In order to solve the above problems, the industry has proposed a variety of GPU sharing schemes, and driven by a cloud native trend, using cloud native technology and standard Docker (Application Container Engine) for containerized deployment has become a common method for heterogeneous computing resources in cloud services in the industry. However, the existing schemes usually have some problems, such as continuous adaptation, difficulty in covering all scenarios, inability to conduct security isolation or low security, and difficulty in secondary development. Therefore, how to run multiple tasks on the same GPU card at the same time and strictly isolate the shared resources is an important direction of industrial research.

### SUMMARY OF THE INVENTION

The embodiments of the present disclosure provide a GPU computing resource management method and apparatus, electronic device and readable storage medium, so as to solve the problems of difficult GPU resource management, low utilization efficiency of GPU resources and difficult to quickly apply for and recover GPU resources.

The embodiments of the present disclosure discloses a GPU computing resource management method, wherein the method is applied to a GPU sharing system, the GPU sharing system is deployed with a Kubernetes cluster, and the Kubernetes cluster includes a plurality of Node nodes and a plurality of Pod services, wherein each of the Node nodes includes a plurality of GPUs, and GPU computing resources corresponding to the GPU at least include a GPU video memories and a GPU computing cores, the method including:
dividing the GPU in the Node nodes to obtain a plurality of vGPUs (virtual Graphics Processing Unit), wherein, each of the vGPUs includes a part of GPU video memories and a part of GPU computing cores of the GPU, and one vGPU corresponds to one Pod service;
collecting vGPU information of each of the vGPUs in the Node nodes, and registering each vGPU information to obtain Pod information of each Pod service corresponding to each vGPU;
receiving each Pod information and saving each Pod information as a file respectively; and
managing the part of GPU video memories and the part of GPU computing cores in each vGPU according to each file.

In some embodiments of the present disclosure, dividing the GPU in each of the Node nodes to obtain a plurality of vGPUs includes:
when dividing the GPU in the Node nodes, allocating the GPU video memories and GPU computing cores of the GPU to each of the vGPUs according to a preset resource quota, so as to obtain a plurality of vGPUs containing the part of GPU video memories and the part of GPU computing cores.

In some embodiments of the present disclosure, the vGPU information at least includes an amount of the vGPUs and a size of the GPU video memories of the vGPU.

In some embodiments of the present disclosure, the Kubernetes cluster further includes Master nodes, and the Master nodes include hijacking schedulers, the step of collecting vGPU information of each of the vGPUs in the Node nodes, and registering each vGPU information to obtain Pod information of each Pod service corresponding to each vGPU includes:
collecting vGPU information of each of the vGPUs in the Node nodes;
sending each vGPU information to the hijacking schedulers in the Master nodes, and registering each vGPU information to obtain Pod information of each Pod service corresponding to each vGPU.

In some embodiments of the present disclosure, receiving each Pod information and saving each Pod information as a file respectively includes:
receiving the Pod information of each Pod service corresponding to each vGPU returned by the hijacking scheduler, and saving each Pod information as a file respectively.

In some embodiments of the present disclosure, the Pod information at least includes a usage of the GPU video memories and a usage of the GPU computing cores in the vGPU.

In some embodiments of the present disclosure, managing the part of GPU video memories and the part of GPU computing cores in each vGPU according to each file includes:
saving the usage of the GPU video memories and the usage of the GPU computing cores corresponding to vGPUs in the Pod information as the files;
controlling a process of the Pod service according to the usage of the GPU video memories and the usage of the GPU computing cores corresponding to vGPUs in the files.

In some embodiments of the present disclosure, controlling a process of the Pod service according to the usage of the GPU video memories and the usage of the GPU computing cores corresponding to vGPUs in the files includes:
if the usage of the GPU video memories and the usage of the GPU computing cores corresponding to vGPUs in the files exceed preset resource quotas, controlling the GPU video memories and the GPU computing cores in the vGPU to terminate the process of the Pod service;
if the usage of the GPU video memories and the usage of the GPU computing cores corresponding to vGPUs in the files meet the preset resource quotas, the process of the Pod service running normally.

In some embodiments of the present disclosure, the method further includes:
expanding and contracting an amount of the Pod services according to the usage of the GPU video memories and the usage of the GPU computing cores in each vGPU.

In some embodiments of the present disclosure, the GPU is located on a host computer, and the host computer at least includes a CPU and a memory, and the Pod service is bound with the CPU and the memory, and expanding and contracting an amount of the Pod services according to the usage of the GPU video memories and the usage of the GPU computing cores in each vGPU includes:
acquiring a CPU utilization rate corresponding to the CPU and an average memory utilization rate corresponding to the memory in the host computer;
automatically expanding and contracting the amount of the Pod services according to the CPU utilization rate and the average memory utilization rate.

In some embodiments of the present disclosure, automatically expanding and contracting the amount of the Pod services according to the CPU utilization rate and the average memory utilization rate includes:
if the CPU utilization rate and/or the average memory utilization rate corresponding to the Pod services are lower than a preset utilization rate, automatically contracting the amount of the Pod services to contract the amount of the vGPUs corresponding to the Pod services;
if the CPU utilization rate and/or the average memory utilization rate corresponding to the Pod services are higher than the preset utilization rate, automatically expanding the amount of the Pod services to expand the amount of the vGPUs corresponding to the Pod services.

In some embodiments of the present disclosure, expanding and contracting an amount of the Pod services according to the usage of the GPU video memories and the usage of the GPU computing cores in each vGPU includes:
acquiring a real-time service request flow of the Pod services;
automatically expanding and contracting the amount of the Pod services according to the real-time service request flow of the Pod services.

In some embodiments of the present disclosure, automatically expanding and contracting the amount of the Pod services according to the real-time service request flow of the Pod services includes:
if the real-time service request flow of the Pod services is greater than a preset real-time service request flow, automatically expanding the amount of the Pod services to expand the amount of the vGPUs corresponding to the Pod services;
if the real-time service request flow of the Pod services is less than the preset real-time service request flow, automatically contracting the amount of the Pod services to contract the amount of the vGPUs corresponding to the Pod services.

In some embodiments of the present disclosure, the method further includes:
when an amount of the automatically expanded and contracted Pod services meets the preset resource quota of the Pod services, scheduling the Pod services to a target GPU.

In some embodiments of the present disclosure, the Kubernetes cluster further includes Master nodes, and the Master nodes include controllers, and the controllers are configured to create resources corresponding to different types of the Pod services.

In some embodiments of the present disclosure, the resources at least include a deployment, a service and a statefulset.

In some embodiments of the present disclosure, the deployment is configured to deploy stateless Pod services, the service is configured to deploy Pod service that may scale to zero, and the statefulset is configured to deploy stateful Pod services.

The embodiments of the present disclosure also discloses a GPU computing resource management apparatus, wherein the method is applied to a GPU sharing system, the GPU sharing system is deployed with a Kubernetes cluster, and the Kubernetes cluster includes a plurality of Node nodes and a plurality of Pod services, wherein each of the nodes includes a plurality of GPUS, and GPU computing resources corresponding to the GPU at least include a GPU video memories and a GPU computing cores, the apparatus including:
a GPU dividing module, configured to divide the GPU in the Node nodes to obtain a plurality of vGPUs (virtual Graphics Processing Unit), wherein, each of the vGPUs includes a part of GPU video memories and a part of GPU computing cores of the GPU, and one vGPU corresponds to one Pod service;
a Pod information acquisition module, configured to collect vGPU information of each of the vGPUs in the Node nodes, and registering each vGPU information to obtain Pod information of each Pod service corresponding to each vGPU;
a Pod information file generation module, configured to receive each Pod information and save each Pod information as a file respectively; and
   a resource management module, configured to manage the part of GPU video memories and the part of GPU computing cores in each vGPU according to each file.

In some embodiments of the present disclosure, the GPU dividing module is specifically configured to:
when dividing the GPU in the Node nodes, allocate the GPU video memories and GPU computing cores of the GPU to each of the vGPUs according to a preset resource quota, so as to obtain a plurality of vGPUs containing the part of GPU video memories and the part of GPU computing cores.

In some embodiments of the present disclosure, the Kubernetes cluster further includes Master nodes, wherein the Master nodes include a hijacking scheduler, and the Pod information acquisition module is specifically configured to:
collect vGPU information of each of the vGPUs in the Node nodes;
send each vGPU information to the hijacking schedulers in the Master nodes, and register each vGPU information to obtain Pod information of each Pod service corresponding to each vGPU.

In some embodiments of the present disclosure, the Pod information file generation module is specifically configured to:
receive the Pod information of each Pod service corresponding to each vGPU returned by the hijacking scheduler, and save each Pod information as a file respectively.

In some embodiments of the present disclosure, the resource management module is specifically configured to:
save the usage of the GPU video memories and the usage of the GPU computing cores corresponding to vGPUs in the Pod information as the files;
control a process of the Pod service according to the usage of the GPU video memories and the usage of the GPU computing cores corresponding to vGPUs.

The embodiment of the present disclosure also discloses an electronic device, which includes a processor, a communication interface, a memory and a communication bus, wherein the processor, the communication interface and the memory communicate with each other through the communication bus;
the memory is configured to store computer programs;
the processor is configured to implement the method according to the embodiment of the present disclosure when executing the programs stored in the memory.

The embodiment of the present disclosure also discloses a non-transitory readable storage medium, on which instructions are stored, which, when executed by one or more processors, cause the processors to perform the method according to the embodiment of the present disclosure.

The embodiments of the present disclosure include the following advantages:

In the embodiments of the present disclosure, it is applied to a GPU sharing system, which is deployed with a Kubernetes cluster, and the Kubernetes cluster includes Node nodes and Pod services, wherein each of the Node nodes includes a plurality of GPUs, and GPU computing resources corresponding to the GPUs at least include GPU video memories and GPU computing cores. By dividing the GPUs in the Node nodes, a plurality of vGPUs can be obtained, wherein, each vGPU includes a part of GPU video memories and a part of GPU computing cores, and one vGPU corresponds to one Pod service. By dividing the GPUs in the Node nodes, the plurality of vGPUs can be obtained, which can support multiple Pod services to run on the same physical GPU and can strictly isolate the GPU computing resources. Then, the vGPU information of each vGPU in the Node node is collected, and each vGPU information is registered to obtain the Pod information of each Pod service corresponding to each vGPU. Each Pod information is received, and each Pod information is saved as a file respectively, and then part of GPU video memories and part of GPU computing cores in each vGPU are managed according to each file. By the Pod information of each Pod service, part of GPU video memories and part of GPU computing cores in each vGPU are managed, which effectively solves a problem of GPU computing resources exceeding the limit.

### BRIEF DESCRIPTION OF DRAWINGS

FIG. 1 is a flowchart of a GPU computing resource management method provided in an embodiment of the present disclosure;

FIG. 2 is a schematic architecture diagram of a GPU sharing system provided in an embodiment of the present disclosure;

FIG. 3 is a schematic diagram of code execution of a configuration file provided in an embodiment of the present disclosure;

FIG. 4 is a schematic diagram of a capacity expansion and contraction mode architecture provided in an embodiment of the present disclosure;

FIG. 5 is a schematic diagram of resource allocation of a multi-service shared GPU provided in an embodiment of the present disclosure;

FIG. 6 is a first schematic diagrams of a scheduling mode of multi-service shared resources provided in the embodiment of the present disclosure;

FIG. 7 is a second schematic diagram of the scheduling mode of multi-service shared resources provided in the embodiment of the present disclosure;

FIG. 8 is a structural block diagram of a GPU computing resource management apparatus provided in an embodiment of the present disclosure;

FIG. 9 is a schematic structural diagram of a non-transitory readable storage medium provided in an embodiment of the present disclosure;

FIG. 10 is a schematic diagram of a hardware structure of an electronic device for implementing various embodiments of the present disclosure.

### DETAILED DESCRIPTION

In order to make the above purposes, features and advantages of the present disclosure more obvious and easy to understand, the present disclosure will be further described in detail with the appended drawings and specific embodiments.

In order to make persons skilled in the field better understand the technical scheme of the embodiments of the present disclosure, some technical features involved in the embodiments of the present disclosure are explained and described below:

Kubernetes (k8s for short) is a portable and extensible open source platform for managing containerized workloads and services, which can promote declarative configuration and automation.

Container technology, Docker is used as an open source application container engine to provide flexible application deployment methods; Kubernetes is an open source project that automates the deployment, expansion and management of containerized applications. It can be used in edge computing platforms to provide reliable and extensible container orchestration.

Pod, a smallest unit of Kubernetes scheduling.

GPU (Graphics Processing Unit) is a kind of microprocessor that specializes in image and graphics related operations on personal computers, workstations, game machines and some mobile devices.

Model inference service, a result model obtained by AI training is transformed into a service, which can perform model inferencing operation.

Node, Kubernetes Node, and Kubernetes Node can be divided into Master and Node, where Master is a management node and Node is a calculation node.

CRD (Custom Resource Definition) is a mechanism that can extend a Kubernetes API (Application Programming Interface) without changing codes to manage custom objects.

Elastic expansion, according to set expansion rules, in actual operation, automatically control the amount of instances.

Model inference service, which transforms the result model obtained by AI training into a service and can perform model inferencing operation.

CDUA (Compute Unified Device Architecture) is a general parallel computing architecture introduced by NVIDIA, which enables GPU to solve complex computing problems. It includes CUDA instruction set architecture (ISA) and parallel computing engine inside GPU.

As an example, for artificial intelligence developers, GPU-based AI system (research institutions) or new/traditional enterprises undergoing digital transformation, when using GPU computing resources, there are bound to be some problems, such as difficulties in managing GPU resources, low efficiency in using GPU resources and difficulties in quickly applying for and recycling GPU resources. In order to solve this problem, the industry has proposed a variety of GPU sharing schemes. And driven by the cloud native trend, using cloud native technology and standard Docker for containerized deployment has become a common method for heterogeneous computing resources in cloud services in the industry. The existing GPU sharing scheme is shown in Table 1:

TABLE 1

| | representative | | |
|---|---|---|---|
| scheme | scheme | advantages | disadvantatages |
| CUD | rCUDA | Nvidia open source | CUDA library is actively upgraded, and |
| hijacking | VCUDA | CUDA API, can | the scheme needs to be constantly |
| | | perform customized | adapted; it is difficult to cover all the |
| | | development | scenes, and the isolation is not |
| | | | necessarily accurate; low security, users |
| | | | can bypass the restrictions; it is |
| | | | impossible to provide accurate |
| | | | calculation force for limit ability |
| CUDA | Nvidia MPS | Performance is best | Errors are transmitted between each |
| polymerization | | when multitasking is | other, and it is difficult to land in the |
| | | shared; when resources | production environment and training |
| | | are satisfied, JCT is not | scenes; No significant isolation; |
| | | affected | Secondary development is not possible |
| Kernel | cGPU | High security; small | Depends on the operating system |
| hijacking | | performance loss for | model and version; Secondary |
| | | sharing; fixed operating | development is difficult and migration is |
| | | system for less work of | difficult |
| | | adaption | |
| Mdev | Nvidia vGPU | Nvidia official | Containerization is not supported, and |
| framework | | components, high | VM usage is limited. Cannot |
| | | reliability and safety | dynamically adjust resource ratio; There |
| | | | is a certain sharing loss; Secondary |
| | | | development is not possible |

As can be seen from Table 1, the existing GPU sharing schemes usually have some problems, such as continuous adaptation, difficulty in covering all scenarios, inability to conduct security isolation or low security, and difficulty in secondary development. Therefore, how to run multiple tasks on the same GPU card at the same time and strictly isolate shared resources is an important direction of industrial research.

In this regard, one of core points of the present disclosure is that it is applied to a GPU sharing system, which is deployed with a k8s cluster, and the k8s cluster includes Node nodes and Pod services, wherein each of the Node nodes includes a plurality of GPUs, and GPU computing resources corresponding to the GPU at least include a GPU video memories and a GPU computing cores. By dividing the GPUs in the Node nodes, a plurality of vGPUs can be obtained, wherein, each vGPU includes a part of GPU video memories and a part of GPU computing cores, and one vGPU corresponds to one Pod service. By dividing the GPUs in the Node nodes, the plurality of vGPUs can be obtained, which can support multiple Pod services to run on the same physical GPU and can strictly isolate the GPU computing resources. Then, the vGPU information of each vGPU in the Node node is collected, and each vGPU information is registered to obtain the Pod information of each Pod service corresponding to each vGPU. Each Pod information is received, and each Pod information is saved as a file respectively, and then part of GPU video memories and part of GPU computing cores in each vGPU are managed according to each file. By the Pod information of each Pod service, part of GPU video memories and part of GPU computing cores in each vGPU are managed, which effectively solves a problem of GPU computing resources exceeding the limit.

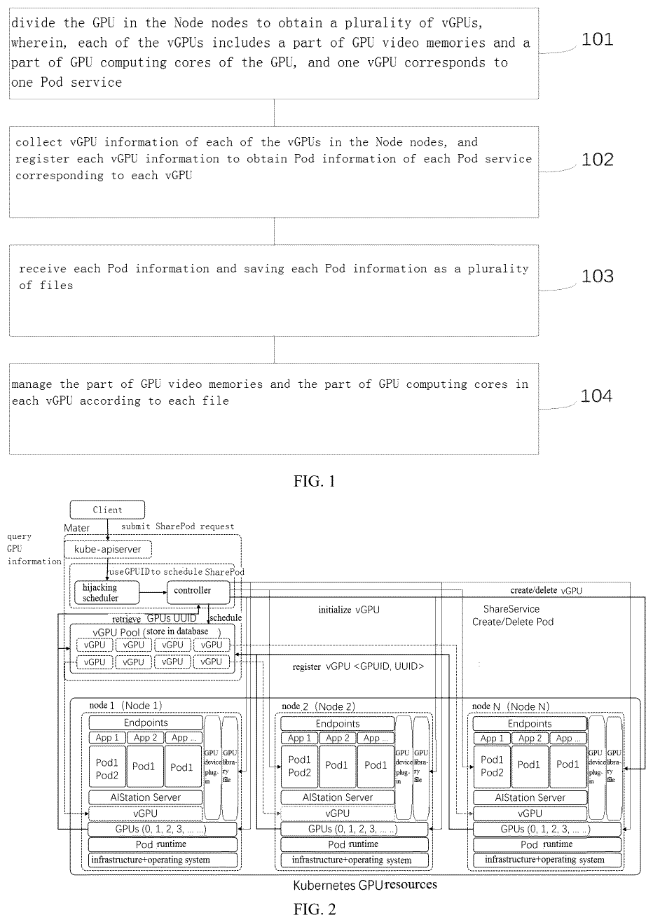

Referring to FIG. 1, it shows the flow chart of a GPU computing resource management method provided in the embodiment of the present disclosure, which is applied to a GPU sharing system. The GPU sharing system is deployed with a k8s cluster, and the k8s cluster includes a plurality of Node nodes and a plurality of Pod services, wherein each of the nodes comprises a GPU, and GPU computing resources corresponding to the GPU at least include a plurality of GPU video memories and computing cores, specifically including the following steps.

Step 101, dividing the GPU in the Node nodes to obtain a plurality of vGPUs, wherein, each of the vGPUs includes a part of GPU video memories and a part of GPU computing cores of the GPU, and one vGPU corresponds to one Pod service;

Referring to FIG. 2, it shows the architecture diagram of a GPU sharing system provided in the embodiment of the present disclosure. The GPU computing resources management method provided in the embodiment of the present disclosure can be applied to the GPU sharing system shown in FIG. 2. Specifically, a k8s cluster is deployed in the GPU sharing system, wherein the k8s cluster can include one or more Node nodes and Pod services, and each Node node can include one or more GPUs, and the GPU computing resources corresponding to each GPU at least include a GPU video memories and a GPU computing cores. Based on this GPU sharing system, a plurality of Pod services can be deployed to the same physical GPU. Moreover, a user can specify a size of the GPU video memories and a proportion of computing cores occupied by each Pod service, and at the same time, it can realize safe resource isolation and solve the problem of resource overrun.

For k8s, it is a portable and extensible open source platform for managing containerized workloads and services, which can promote declarative configuration and automation. The k8s cluster can include a plurality of physical devices or virtual machines. Specifically, the k8s cluster can include one or more Node nodes and Pod services, wherein each Node node can include one or more GPUs; Wherein, the Node node is a computing node in k8s, which can be responsible for running the related containers in the cluster and managing the data transmitted by the containers.

As for Pod, it is the smallest unit of Kubernetes scheduling, which can represent a single running process instance in a Kubernetes cluster. There can be a plurality of Containers in a Pod, and one container can include an AI service. Therefore, a Pod can form a large AI service from the AI services in a plurality of containers. It can be understood that there is one container in a Pod, one container mounts a vGPU, one Pod uses one vGPU, and one vGPU corresponds to one Pod service. It should be noted that, for a usage form of the Pod, for the convenience of explanation, all data are set to be relatively simple. In practical application, the usage form of the Pod may be more complicated, and the usage form may be different according to actual application scenarios.

For vGPUs (Virtual Graphics Processing Unit), the vGPUs are obtained by dividing the GPUs in Node nodes, it can be that a full-card GPU is virtualized into a plurality of vGPUs, and the vGPUs are finely divided from the full-card GPU. As shown in FIG. 2, there are Node nodes in the GPU sharing system, and there are a plurality of GPUs in each Node node, and there are a plurality of vGPUs obtained by dividing the GPUs, and the plurality of vGPUs form a vGPU pool.

For GPU, it can be located on the Node node. GPU is a kind of microprocessor that specializes in image and graphics related operations on personal computers, workstations, game machines and some mobile devices. Wherein, GPU includes GPU computing resource, and the GPU computing resource can include a GPU video memories and a GPU computing cores; GPU video memories can be understood as a kind of space, similar to memory, which is used to store models, data, etc. The larger the GPU video memories, the larger the network it can run. The GPU video memories will become more important in large-scale training. For GPU computing cores, it can be used to perform all graphics operations and general operations of GPU.

In the embodiment of the present disclosure, in the GPU sharing system, a plurality of vGPUs can be obtained by dividing the GPUs in the Node node. Specifically, in a process of dividing, a part of GPU video memories and a part of GPU computing cores are allocated to the plurality of vGPUs respectively according to a preset resource quota, so as to obtain a plurality of vGPUs including the part of GPU video memories and the part of GPU computing cores. Wherein, one vGPU can correspond to one Pod service and the GPU computing resources occupied by the plurality of the Pod services running on the same GPU card are independently divided. By dividing the GPU in the Node node into a plurality of vGPUs, a plurality of Pod services can be supported to run on the same physical GPU, and the GPU computing resources can be strictly isolated.

For the preset resource quota, it can set as a size of the GPU video memories and the GPU computing cores required when creating a Pod service or application by the user, so that the part of GPU video memories and the part of GPU computing cores can be allocated to the plurality of vGPUs respectively according to the preset resource quota.

Step 102, collecting vGPU information of each of the vGPUs in the Node nodes, and registering each vGPU information to obtain Pod information of each Pod service corresponding to each vGPU;

The vGPU information can include an amount of the vGPUs and a sizes of the vGPU video memories of the vGPU; For Pod information, it can include a usage of some GPU video memories and a usage of some GPU computing cores of the GPUs included in the vGPU; Wherein, the usage can be the usage of the GPU video memories or the computing cores by the Pod service. For example, the usage can be that the GPU video memories consumed by the Pod service exceeds the preset resource quota, or the GPU video memories consumed by the Pod service is within the preset resource quota. For the preset resource quota, it can be a resource quota of the GPU video memories and a resource quota of the GPU computing cores set according to a preset configuration file.

In this embodiment of the present disclosure, after dividing the GPU in the Node node to obtain a plurality of vGPUs, the amount of the vGPUs and the sizes of the vGPU video memories of each vGPU in the Node node are collected, and the amount and the sizes of the vGPU video memories of each vGPU are registered to obtain the Pod information of each Pod service corresponding to each vGPU, that is, the usage of the part of GPU video memories and the part of GPU computing cores of GPU included in each vGPU is obtained.

Step 103, receiving each Pod information and saving each Pod information as a file respectively;

For the file, it can be a file including the usage of the part of GPU video memories and the part of GPU computing cores of GPUs included in each vGPU.

In the embodiment of the present disclosure, after the GPU in the Node node is divided to obtain a plurality of vGPUs, the amount of vGPUs and the sizes of vGPU video memories of each vGPU in the Node node are collected, and the amount of vGPUs and the sizes of vGPU video memories of each vGPU are registered to obtain the usage of the part of GPU video memories and the part of GPU computing cores by each Pod service corresponding to each vGPU. The usage of the part of GPU video memories and the part of GPU computing cores of each Pod service are received, and the data is saved as a file.

Step 104, managing the part of GPU video memories and the part of GPU computing cores in each vGPU according to each file.

In the specific implementation, according to the usage of the part of GPU video memories and the part of GPU computing cores by each Pod service included in the file, it is determined whether the usage of the part of GPU video memories and the part of GPU computing cores by the Pod service exceeds the preset resource quota, so as to control the progress of the Pod service and further manage the part of GPU video memories and the part of GPU computing cores in each vGPU.

In the embodiment of the present disclosure, it is applied to a GPU sharing system, which is deployed with a k8s cluster, and the k8s cluster includes Node nodes and Pod services, wherein each of the Node nodes includes a plurality of GPUs, and GPU computing resources corresponding to the GPUs at least include GPU video memories and GPU computing cores. By dividing the GPUs in the Node nodes, a plurality of vGPUs can be obtained, wherein, each vGPU includes a part of GPU video memories and a part of GPU computing cores, and one vGPU corresponds to one Pod service. By dividing the GPUs in the Node nodes, the plurality of vGPUs can be obtained, which can support multiple Pod services to run on the same physical GPU and can strictly isolate the GPU computing resources. Then, the vGPU information of each vGPU in the Node node is collected, and each vGPU information is registered to obtain the Pod information of each Pod service corresponding to each vGPU. Each Pod information is received, and each Pod information is saved as a file respectively, and then part of GPU video memories and part of GPU computing cores in each vGPU are managed according to each file. By the Pod information of each Pod service, part of GPU video memories and part of GPU computing cores in each vGPU are managed, which effectively solves a problem of GPU computing resources exceeding the limit.

In an alternative embodiment, the k8s cluster also includes Master Nodes, which include hijacking schedulers. Step 102, collecting the vGPU information of each of the vGPUs in the Node nodes, and registering each vGPU information to obtain the Pod information of each Pod service corresponding to each vGPU, including:
collecting vGPU information of each vGPU in the Node node;
sending each vGPU information to the hijacking scheduler in the Master node, registering each vGPU information, and obtaining the Pod information of each Pod service corresponding to each vGPU.

The Master Node is a management node in the k8s cluster, which can be a node deployed in a central server of the cluster and is responsible for associating with other nodes, such as managing the Node nodes.

As for the hijacking scheduler, it can be a GPUSharing Scheduler, which can be used to count, manage and schedule a plurality of Pod services sharing GPU computing resources of the same GPU card, and it can restrict the usage of GPU computing resources in a software layer by hijacking the usage of the GPU video memories and GPU computing cores in real time. Specifically, The real-time resource usage and status of the Pod service can be collected by the hijacking scheduler, and the service can be monitored strictly according to a pre-allocated resource size. If the resource quota is exceeded, the process of the Pod service exceeding ta maximum preset value of resources can be controlled, and the process at this time can be in an interrupted state.

In this embodiment of the present disclosure, the vGPU information of each vGPU in the Node node is collected, and each vGPU information is sent to the hijacking scheduler in the Master node, and each vGPU information is registered to obtain the Pod information of each Pod service corresponding to each vGPU.

As can be seen from FIG. 2, the k8s cluster also includes Master Nodes, which include hijacking schedulers (GPUSharing Scheduler). Each Node node is responsible for collecting all vGPUs of each Node node and sending all vGPU information to the hijacking scheduler (GPUSharing Scheduler) for information registration, so that Pod information of each Pod service corresponding to each vGPU can be obtained.

In an alternative embodiment, step 103, receiving each Pod information and saving each Pod information as a file respectively includes:
receiving the Pod information of each Pod service corresponding to each vGPU returned by the hijacking scheduler, and saving each Pod information as a file respectively.

For the file, it can be a file including the usage of part of GPU video memories and part of GPU computing cores of GPUs included in each vGPU.

In the embodiment of the present disclosure, after the GPUs in the Node node are divided to obtain a plurality of vGPUs, the vGPU information of each vGPU in the Node node is collected, each vGPU information is sent to the hijacking scheduler in the Master node, and each vGPU information is registered to obtain the Pod information of each Pod service corresponding to each vGPU. That is, the usage of the part of GPU video memories and the part of GPU computing cores by each Pod service corresponding to each vGPU is obtained by the hijacking scheduler registration, and the usage of the part of GPU video memories and the part of GPU computing cores by each Pod service returned by the hijacking scheduler is received, and the data is saved as a file. By saving the data as a file, it provides convenience for further resource management.

In an alternative embodiment, step 104, managing the part of GPU video memories and the part of GPU computing cores in each vGPU according to each file, includes:
saving the usage of the GPU video memories and the usage of the GPU computing cores corresponding to vGPUs in the Pod information as the files;
controlling the process of the Pod service according to the usage of the GPU video memories and the usage of the GPU computing cores corresponding to vGPUs in the file.

For the Pod information, it may include the usage of the part of GPU video memories and the usage of the part of GPU computing cores of GPUs included in the vGPUs; Wherein, the usage can be the usage of GPU video memories or computing cores by the Pod service. Illustratively, the usage can be that the GPU video memories consumed by the Pod service exceeds the preset resource quota, or the GPU video memories consumed by the Pod service is within the preset resource quota.

In one example, if the usage of the GPU video memories and the usage of the GPU computing cores corresponding to vGPU in the file exceeds the preset resource quota, the GPU video memories and GPU computing cores in vGPU are controlled to terminate the process of Pod service, that is, if the usage of the GPU video memories and the usage of the GPU computing cores corresponding to vGPU in the file meet the preset resource quota, the process of Pod service will run normally.

In this embodiment of the present disclosure, the usage of GPU video memories and the usage of GPU computing cores corresponding to vGPU in Pod information are saved as files, and the progress of Pod service is controlled according to the usage of the GPU video memories and the usage of the GPU computing cores corresponding to vGPU in the file. Specifically, the usage of GPU video memories and the usage of GPU computing cores of vGPU corresponding to Pod service can be collected by the hijacking scheduler, and the service can be monitored strictly in accordance with the preset resource quota to control the progress of Pod service.

It should be noted that, for methods of limiting GPU video memory and controlling GPU time slice, in addition to the method that GPU nodes start the scheduler to limit the GPU video memories and control GPU time slice based on the CUDA dynamic library hijacking method in the embodiment of the present disclosure, ta spatial scheduling mode can also be used in combination with MPS (push-to-stack instruction) technology, which can be selected by those skilled in the art according to the actual situation, and the embodiments of the present disclosure do not limit this.

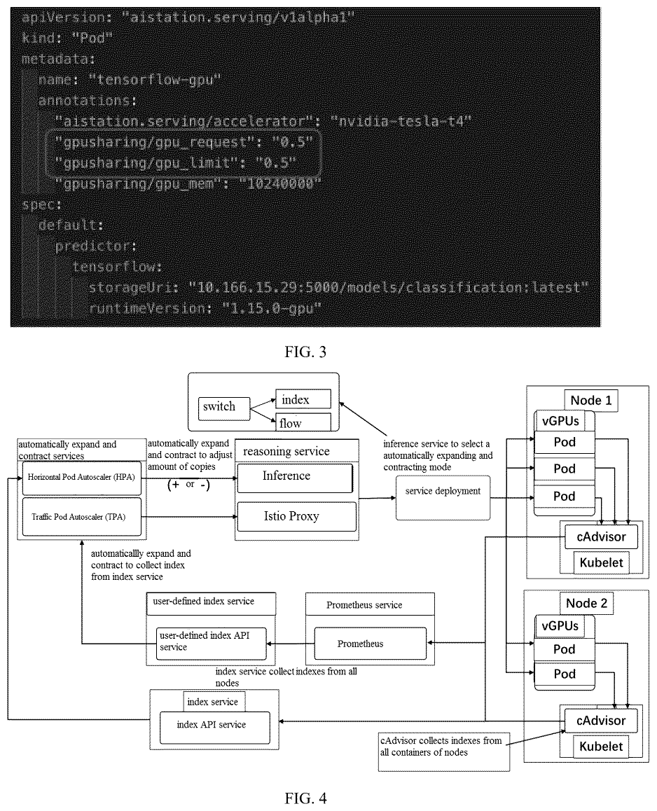

It is worth mentioning that for the preset resource quota, it can be the resource quota of GPU video memories and GPU computing cores set according to the preset configuration file, and the resource quota of GPU video memories and GPU computing cores required by Pod service can be set by the configuration file. Referring to FIG. 3, a schematic diagram of code execution of a configuration file provided in the embodiment of the present disclosure is shown. In the embodiment of the present disclosure, The GPU sharing system does not need to modify a design of the Extended Resource and the implementation of the Scheduler of the Kubernetes (k8s) core, but can use NVIDIA Device Plugin and native Kubernetes, which has no influence on underlying drivers (CUDA Driver, NVIDIA Driver) and CUDA Runtime, and fine-grained deployment of services can be achieved only by using the Kubernetes yaml file.

In an alternative embodiment, the method further includes:

According to the usage of the GPU video memories and usage of the GPU computing cores in each vGPU, the amount of the Pod services is expanded and contracted.

For expansion and contraction, it can be to expand the amount of Pod services or to contract the amount of Pod services. Since one Pod service corresponds to one vGPU, that is, the expansion of Pod services is actually to expand the amount of the vGPUs, and the contraction of Pod services is actually to contract the amount of the vGPUs.

In the specific implementation, according to the usage of GPU video memories and the usage of GPU computing cores in each vGPU, the amount of Pod services is expanded to expand the amount of vGPUs. By expanding the amount of Pod services, the GPU sharing system can schedule the services with a maximum integration rate to the same GPU card, and further improve a utilization rate of GPU resources in the existing cluster more efficiently.

Referring to FIG. 4, it shows a schematic diagram of the capacity expansion and contraction mode architecture provided in the embodiment of the present disclosure. As can be seen from the figure, there are two capacity expansion and contraction modes in the embodiment of the present disclosure, one is based on HPA (Horizontal Pod Autoscaler) and the other is based on TPA (Traffic Pod Autoscaler). Wherein, the capacity expansion and contraction mode of HPA can make user applications or services realize the horizontal capacity expansion and contraction of Pod services according to a utilization rate of CPU, memory and other resources, while TPA can make user applications or services realize the horizontal capacity expansion and contraction of Pod according to a busy degree of business, in which the busy degree of business can be real-time service request traffic.

In an alternative embodiment, the GPU is located on a host, and the host at least includes a CPU and a memory, and the Pod service is bound with the CPU and the memory, and the amount of Pod services is expanded and contracted according to the usage of GPU video memories and GPU computing cores in each vGPU, including:
obtaining the CPU utilization rate corresponding to the CPU in the host and the average memory utilization rate corresponding to the memory;
automatically expanding and contracting the amount of Pod services according to CPU utilization and average memory utilization.

For CPU, it can be a final execution unit of information processing and program running; For memory, it is an important part of computer, also called internal memory and main memory, which is used to temporarily store the operation data in CPU and the data exchanged with external memory such as hard disk.

In the embodiment of the present disclosure, the CPU utilization rate corresponding to the CPU and the average memory utilization rate corresponding to the memory in the host are obtained, and the amount of Pod services is automatically expanded and contracted according to the CPU utilization rate and the average memory utilization rate. Specifically, if the CPU utilization rate and/or the average memory utilization rate corresponding to the Pod service are lower than a preset utilization rate, the amount of Pod services is automatically contracted to contract the amount of vGPUs corresponding to the Pod service. If the CPU utilization rate and/or average memory utilization rate corresponding to the Pod service is higher than the preset utilization rate, the amount of Pod services is automatically expanded to expand the amount of vGPUs corresponding to the Pod services, and when an amount of the automatically expanded Pod services meets the preset resource quota of the Pod service, the Pod services are scheduled to a target GPU.

It is worth mentioning that the capacity expansion and contraction mode in the above example is an HPA-based capacity expansion and contraction mode, which can automatically expand and contract the amount of Pod services according to CPU utilization rate and average memory utilization rate.

It should be noted that the above-mentioned examples are only taken as an example, so for the convenience of explanation, all the data are set relatively simply. In practical application, a index of resource utilization rate which the HPA-based capacity expansion and contraction mode are based on may be far more than the CPU utilization rate and the average memory utilization rate. It is understandable that the persons skilled in this field can automatically expand and contract the capacity based on a user-defined measurement index provided by other applications according to the actual situation, and this is not limited by the embodiment of the present disclosure.

In an alternative embodiment, expanding the amount of Pod services according to the usage of GPU video memories and the usage of GPU computing cores in each vGPU includes:
acquiring a real-time service request flow of the Pod services;
automatically expanding and contracting the amount of the Pod services according to the real-time service request flow of the Pod services.

For the real-time service request flow of the Pod services, it can be the amount of server requests (Queries-per-second, QPS for short) when the Pod service is running.

In one example, it is assumed that the amount of real-time service requests that a Pod service can handle is set to 10 per second. When the amount of requests exceeds 10 per second, the amount of Pod services is increased by one and the corresponding number of vGPUs is also increased by one based on the capacity expansion and contraction mode of TPA to cope with a burst traffic.

In another example, suppose a Pod service occupies 10 GB of video memories and 10% of the computing cores on GPU card A, and the resources on GPU card A can handle 100 requests at the same time. When the amount of requests changes greatly (for example, the amount rises to 150 or more requests), the GPU sharing system can apply for resources of the same size on GPU card A, GPU card B or GPU card N with N times of resource quota according to the resources allocated on GPU card A to cope with the burst traffic.

In the embodiment of the present disclosure, the real-time service request flow of the Pod service is obtained, and the amount of the Pod services is automatically expanded and contracted according to the real-time service request flow of the Pod service. Specifically, if the real-time service request flow of the Pod service is greater than the preset real-time service request flow, the amount of the Pod services is automatically expanded to expand the amount of vGPUs corresponding to the Pod services. If the real-time service request flow of the Pod services is less than the preset real-time service request flow, the amount of Pod services is automatically contracted to contract the amount of vGPUs corresponding to the Pod services, when the amount of automatically expanded Pod services meets the preset resource quota of the Pod services, the Pod services are scheduled to the target GPU.

It should be noted that the above-mentioned capacity expansion and contraction mode is a TPA-based capacity expansion and contraction mode, which can automatically expand and contract the amount of Pod services according to the real-time service request flow of Pod services.

In an alternative embodiment, the k8s cluster further includes Master nodes, and the Master nodes include controllers, and the controllers are used to create resources corresponding to different types of Pod services.

The Master Node is a management node in the k8s cluster, which can be a node deployed in the central server of the k8s cluster, and is responsible for associating with other nodes, such as managing Node nodes; For resources, it can include three different types of resources: Deployment, Service and Statefulset. Wherein, Deployment is used to deploy stateless Pod Services, Service is used to deploy Pod services that can be scaled to zero, and Statefulset is used to deploy stateful Pod services.

In an alternative embodiment, the method further includes:
scheduling the Pod services to the target GPU when the amount of automatically expanded Pod services meets the preset resource quota of Pod services.

For the target GPU, it can be a GPU that can meet the resource quota requirements of Pod services.

In the specific implementation, when the amount of automatically expanded Pod services meets the preset resource quota of Pod services, the hijacking scheduler can schedule Pod services to the target GPU, wherein when Pod services applied by a plurality of users run on the same physical GPU, the hijacking scheduler can ensure that the computing resources of vGPU can meet the requirements of Pod when scheduling.

Referring to FIG. 5, a schematic diagram of resource allocation of a multi-service shared GPU provided in an embodiment of the present disclosure is shown. It should be noted that, for convenience of description, the “instance” in FIG. 5 can be represented as a Case, the “container” can be represented as a Container, the “solution” can be represented as a Case Scenario, and the “APP” can be represented as an application or a service. The above naming can be adjusted by a person skilled in the art according to the actual situation, which is not limited by the embodiments of the present disclosure.

As can be seen from the figure, multi-service shared GPU resources can include GPU video memory and GPU computing core. For example, the GPU video memory occupied by Pod service A in GPU card A is 25% (Memory-Container A) and the GPU computing core is 20% (Kernel-Container A); Secondly, users can deploy a plurality of different types of services on the same GPU card. When the GPU video memories required by a plurality of services can meet the actual amount of the GPU video memories in a single GPU, the utilization rate of GPU resources can reach 100%, as shown in Case1 (Example 1) in FIG. 5, a Container can correspond to a Pod service. Container1 is 50%, Container2 is 25%, Container3 is 50%, and Container4 is 75%. As a result, the memory utilization rate of each GPU cannot be fully loaded or nearly fully loaded. At this time, the Pod service with the maximum integration rate can be scheduled to the same GPU card by the GPU sharing system. As shown in the Case Scenario in FIG. 5, a combination of Container1 (50%) and Container3 (50%), or a combination of Container2 (25%) and Container4 (75%) can respectively fully meet a memory quota of the existing GPU resources, and it is understandable that the GPU sharing system can schedule the services with the maximum integration rate to the same GPU card, thus improving the utilization rate of the GPU resources in the existing cluster more efficiently. Moreover, as shown in Case2 (Example 2) in the figure, Container2 needs to occupy 75% of the GPU video memory, but the existing GPU video memories have exceeded 100% (Container 1+Container 2=50%+75%=125%). As shown in Case2 in the figure, there is a part above GPU0 that exceeds a quota of GPU video memory (125%-100%=25%). Therefore, it is necessary to use the hijacking scheduler in the GPU sharing system to schedule resources to the appropriate GPU card. As shown in the Case Scenario in the figure, and the corresponding combination of Container1 and Container4 in Case2 (Container 1+Container 4=50%+50%=100%), a combination of Container2 and Container3 (Container 2+Container 3=75%+25%=100%) and a combination of Container5 and Container6 (Container 5+Container 6=50%+50%=100%), by scheduling resources to the appropriate GPU card, it can maximize the utilization rate of GPU computing resources. Understandably, the GPU sharing system can schedule the services with the maximum integration rate to the same GPU card, thus improving the utilization rate of GPU resources in the existing cluster more efficiently.

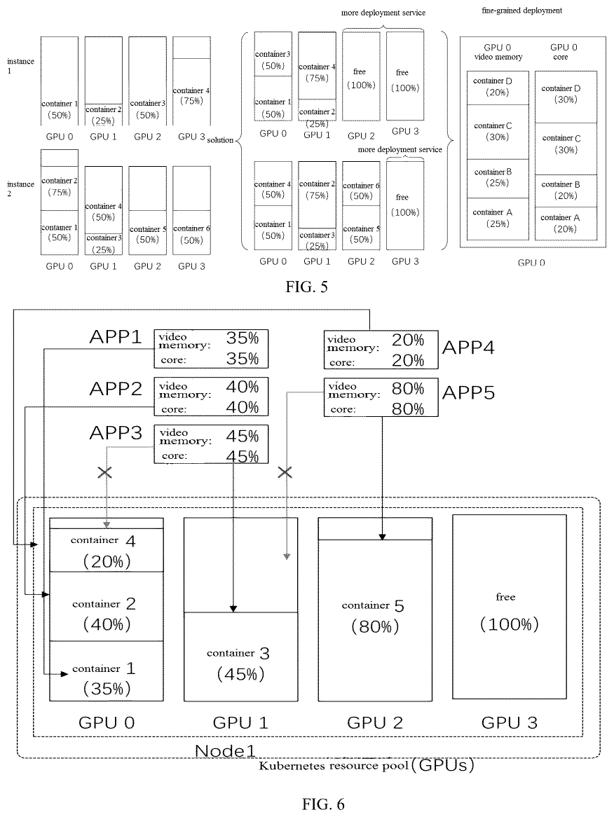

Referring to FIG. 6-7, schematic diagrams of scheduling modes of multi-service shared resources provided in the embodiment of the present disclosure are shown. The GPU sharing system can calculate the optimal scheduling strategy by a background algorithm to provide the minimum remaining resources and service security guarantee scheme for pre-deployed services, that is, to make the Pod service occupy the resources on a GPU card as much as possible, reduce an amount of GPU cards used, reduce fragmentation of GPU computing resources, and provide idle GPU resources for other services after reasonably scheduling services to different GPU cards.

As shown in FIG. 6, in GPU0, the resources occupied by Pod service is close to 100% (Container 1+Container 2+Container 4=95%). Secondly, there are 5% resources left on GPU0, but Container3 (45%) needs to occupy more resources than the remaining 5% resources on GPU0, so it needs to be reallocated to a new GPU. Similarly, there are still 55% resources left on GPU1, but Container5 (80%) needs to occupy more resources than the remaining 55% resources on GPU1, so it needs to be reallocated to a new GPU. Because the combination of Container3 (45%) in GPU1 and Container5 (80%) in GPU2 will exceed 100% of quota of GPU computing resources, they cannot be integrated into one GPU, and need to be allocated to different GPUs respectively.

It should be noted that APP4 and APP5 corresponding to Container4 (20%) and Container5 (80%) in FIG. 6 can also be integrated into one card to meet a usage quota of GPU video memories of a GPU (less than or equal to 100%). It can be understood that the persons skilled in this field can calculate the optimal scheduling strategy according to the actual situation to provide the minimum remaining resources and service security guarantee scheme for the pre-deployed service, which is not limited in the embodiment of the present disclosure.

The above resource scheduling methods are also applicable to cross-node resource allocation schemes. As shown in FIG. 7, on the basis of the scenario in FIG. 6, when Node 1 adds APP6 (85%) and Node 2 adds APP7 (35%), the APP6 (85%) can be scheduled to an idle GPU3 in Node 1, and the APP7 (35%) on Node 2 can be scheduled to a remaining resource space of GPU2 in Node 1. Understandably, the GPU sharing system calculates the optimal scheduling strategy by the background algorithm to provide the minimum remaining resources and service security scheme for the pre-deployed services. After reasonably scheduling services to different GPU cards, idle GPU resources can be provided for other services and resources can be isolated among services.

In the embodiment of the present disclosure, it is applied to a GPU sharing system, which is deployed with a k8s cluster, and the k8s cluster includes Node nodes and Pod services, wherein each of the Node nodes includes a plurality of GPUs, and GPU computing resources corresponding to the GPUs at least include GPU video memories and GPU computing cores. By dividing the GPUs in the Node nodes, a plurality of vGPUs can be obtained, wherein, each vGPU includes a part of GPU video memories and a part of GPU computing cores, and one vGPU corresponds to one Pod service. By dividing the GPUs in the Node nodes, the plurality of vGPUs can be obtained, which can support multiple Pod services to run on the same physical GPU and can strictly isolate the GPU computing resources. Then, the vGPU information of each vGPU in the Node node is collected, and each vGPU information is registered to obtain the Pod information of each Pod service corresponding to each vGPU. Each Pod information is received, and each Pod information is saved as a file respectively, and then part of GPU video memories and part of GPU computing cores in each vGPU are managed according to each file. By the Pod information of each Pod service, part of GPU video memories and part of GPU computing cores in each vGPU are managed, which effectively solves a problem of GPU computing resources exceeding the limit.

Moreover, by the expansion and contraction mode of HPA and the expansion and contraction mode of TPA, under the condition of meeting the preset resource quota of Pod services, the optimal GPU resources can be applied for Pod services according to the fine-grained resource scheduling mode, and the GPU sharing system can schedule the services with the maximum integration rate to the same GPU card, thereby improving the utilization rate of GPU resources in the existing cluster more efficiently. Furthermore, by the background algorithm, the optimal scheduling strategy is calculated to provide the minimum remaining resources and service security guarantee scheme for pre-deployed services, which can reasonably schedule services to different GPU cards, provide idle GPU resources for other services, and ensure resource isolation among services.

It should be noted that for the sake of simple description, the method embodiments are all expressed as a series of action combinations, but those skilled in the art should know that these embodiments of the present disclosure are not limited by the described action sequence, because some steps can be performed in other sequences or at the same time according to the embodiments of the present disclosure. Secondly, those skilled in the art should also know that the embodiments described in the specification belong to some embodiments of the present disclosure, and the actions involved are not necessarily necessary for the embodiments of the present disclosure.

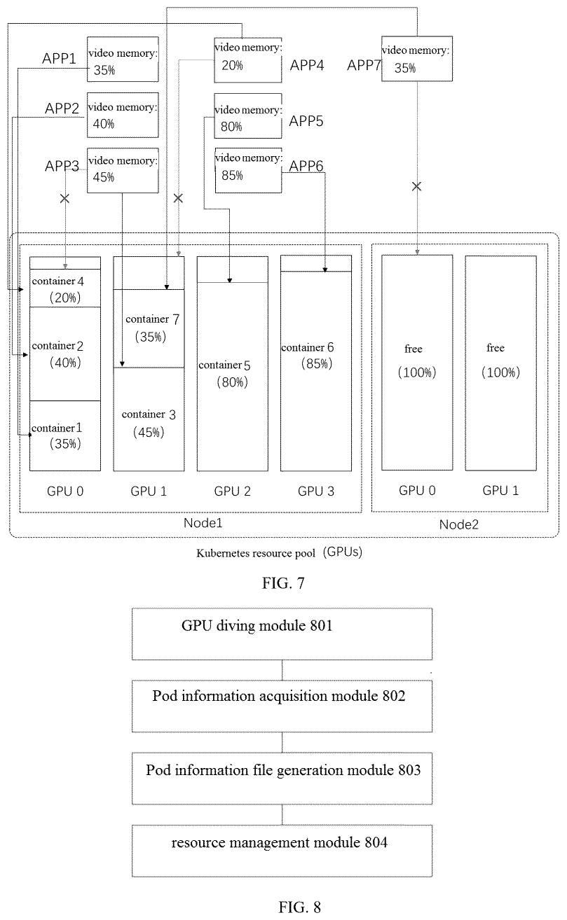

Referring to FIG. 8, the structural block diagram of a GPU computing resource management apparatus provided in the embodiment of the present disclosure is shown, which is applied to a GPU sharing system. The GPU sharing system is deployed with a k8s cluster, and the k8s cluster includes Node nodes and Pod services, wherein the Node node includes a plurality of GPUs, and the GPU computing resources corresponding to the GPU at least include GPU video memories and GPU computing cores, specifically including the following modules:
a GPU dividing module 801, configured to divide the GPU in the Node nodes to obtain a plurality of vGPUs (virtual Graphics Processing Unit), wherein, each of the vGPUs includes a part of GPU video memories and a part of GPU computing cores of the GPU, and one vGPU corresponds to one Pod service;
a Pod information acquisition module 802, configured to collect vGPU information of each of the vGPUs in the Node nodes, and registering each vGPU information to obtain Pod information of each Pod service corresponding to each vGPU;
a Pod information file generation module 803, configured to receive each Pod information and save each Pod information as a file respectively; and
a resource management module 804, configured to manage the part of GPU video memories and the part of GPU computing cores in each vGPU according to each file.

In an alternative embodiment, the GPU dividing module 801 is specifically configured to:
when dividing the GPU in the Node nodes, allocate the GPU video memories and GPU computing cores of the GPU to each of the vGPUs according to a preset resource quota, so as to obtain a plurality of vGPUs containing the part of GPU video memories and the part of GPU computing cores.

In an alternative embodiment, the k8s cluster further includes Master nodes, wherein the Master nodes include a hijacking scheduler, and the Pod information acquisition module 802 is specifically configured to:
collect vGPU information of each of the vGPUs in the Node nodes;
send each vGPU information to the hijacking schedulers in the Master nodes, and register each vGPU information to obtain Pod information of each Pod service corresponding to each vGPU.

In an alternative embodiment, the Pod information file generation module 803 is specifically configured to:
receive the Pod information of each Pod service corresponding to each vGPU returned by the hijacking scheduler, and save each Pod information as a file respectively.

In an alternative embodiment, the resource management module 804 is specifically configured to:
save the usage of the GPU video memories and the usage of the GPU computing cores corresponding to vGPUs in the Pod information as the files;
control a process of the Pod service according to the usage of the GPU video memories and the usage of the GPU computing cores corresponding to vGPUs.

As for the apparatus embodiments, because they are basically similar to the method embodiments, the description is relatively simple, and the relevant points can be found in part of the description of the method embodiments.

Moreover, the embodiment of the present disclosure also provides an electronic device, which includes a processor, a memory, and a computer program stored in the memory and capable of running on the processor. When the computer program is executed by the processor, each process of the above-mentioned GPU computing resource management method embodiment can be realized, and the same technical effect can be achieved, so in order to avoid repetition, it is not repeated here.

FIG. 9 is a schematic structural diagram of a non-transitory readable storage medium provided in an embodiment of the present disclosure.

The embodiment of the present disclosure also provides a non-transitory readable storage medium 901, on which a computer program is stored. When the computer program is executed by a processor, each process of the above-mentioned GPU computing resource management method embodiment can be realized, and the same technical effect can be achieved. In order to avoid repetition, it is not repeated here. Wherein, the non-transitory readable storage medium 901, such as Read-Only Memory (ROM), Random Access Memory (RAM), magnetic disk or optical disk, etc.

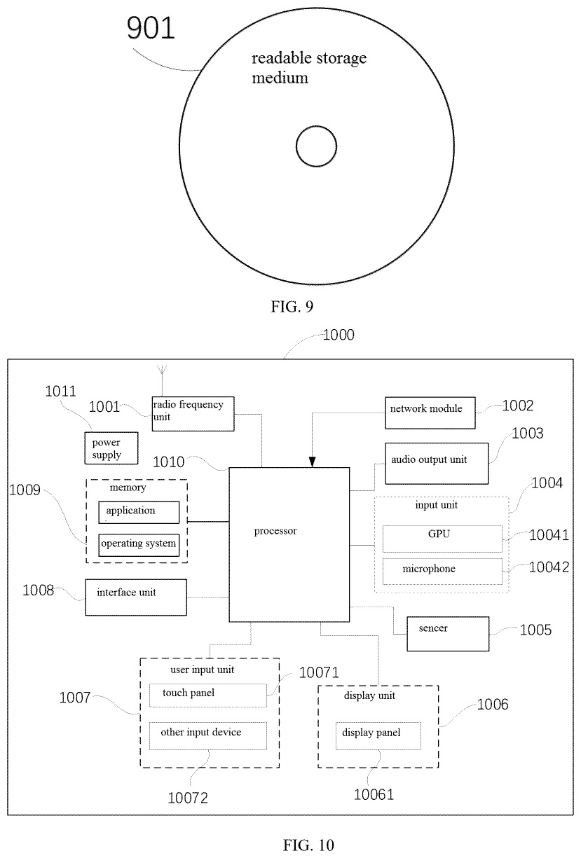

FIG. 10 is a schematic diagram of the hardware structure of an electronic device for implementing various embodiments of the present disclosure.

The electronic device 1000 includes, but is not limited to, a radio frequency unit 1001, a network module 1002, an audio output unit 1003, an input unit 1004, a sensor 1005, a display unit 1006, a user input unit 1007, an interface unit 1008, a memory 1009, a processor 1010, and a power supply 1011. It can be understood by those skilled in the art that the structure of the electronic equipment shown in FIG. 10 does not constitute a limitation to the electronic equipment, and the electronic equipment may include more or less components than shown, or combine some components, or have different component arrangements. In the embodiment of the present disclosure, electronic devices include, but are not limited to, mobile phones, tablet computers, notebook computers, palmtop computers, vehicle-mounted terminals, wearable devices, pedometers and the like.

It should be understood that in this embodiment of the present disclosure, the RF unit 1001 can be used to receive and send signals during the process of receiving and sending information or talking, specifically, the downlink data from the base station is received and processed by the processor 1010; Moreover, the uplink data is sent to the base station. Generally, the RF unit 1001 includes, but is not limited to, an antenna, at least one amplifier, a transceiver, a coupler, a low noise amplifier, a duplexer, and the like. Moreover, the RF unit 1001 can also communicate with networks and other devices through a wireless communication system.

Electronic devices provide users with wireless broadband Internet access through the network module 1002, such as helping users to send and receive emails, browse web pages and access streaming media.

The audio output unit 1003 can convert audio data received by the RF unit 1001 or the network module 1002 or stored in the memory 1009 into audio signals and output them as sound. Moreover, the audio output unit 1003 can also provide audio output related to specific functions performed by the electronic device 1000 (for example, call signal receiving sound, message receiving sound, etc.). The audio output unit 1003 includes a speaker, a buzzer and a receiver.

The input unit 1004 is used to receive audio or video signals. The input unit 1004 may include a Graphics Processing Unit (GPU) 10041 and a microphone 10042. The graphics processor 10041 processes image data of still pictures or videos obtained by an image capture device (such as a camera) in a video capture mode or an image capture mode. The processed image frame can be displayed on the display unit 1006. The image frames processed by the graphics processor 10041 can be stored in the memory 1009 (or other storage media) or transmitted via the radio frequency unit 1001 or the network module 1002. The microphone 10042 can receive sounds and can process such sounds into audio data. The processed audio data can be converted into a format that can be sent to the mobile communication base station via the radio frequency unit 1001 in the case of telephone conversation mode.

The electronic device 1000 also includes at least one sensor 1005, such as a light sensor, a motion sensor and other sensors. Specifically, the optical sensor includes an ambient light sensor and a proximity sensor, wherein the ambient light sensor can adjust the brightness of the display panel 10061 according to the brightness of ambient light, and the proximity sensor can turn off the display panel 10061 and/or backlight when the electronic device 1000 moves to the ear. As a kind of motion sensor, accelerometer sensor can detect the magnitude of acceleration in all directions (generally three axes), and the magnitude and direction of gravity at rest, which can be used to identify the attitude of electronic equipment (such as horizontal and vertical screen switching, related games, magnetometer attitude calibration), vibration identification related functions (such as pedometer, tapping), etc. The sensor 1005 may also include a fingerprint sensor, a pressure sensor, an iris sensor, a molecular sensor, a gyroscope, a barometer, a hygrometer, a thermometer, an infrared sensor, etc., which are not described in detail here.

The display unit 1006 is used to display information input by the user or information provided to the user. The display unit 1006 may include a display panel 10061, which may be configured in the form of a Liquid Crystal Display (LCD) or an organic light-emitting diode (OLED).

The user input unit 1007 can be used to receive input digital or character information and generate key signal input related to user settings and function control of electronic equipment. Specifically, the user input unit 1007 includes a touch panel 10071 and other input devices 10072. The touch panel 10071, also known as a touch screen, can collect the touch operations of users on or near it (such as the operations of users on or near the touch panel 10071 with any suitable objects or accessories such as fingers and a stylus). The touch panel 10071 may include a touch detection device and a touch controller. Wherein, the touch detection device detects the touch orientation of the user, detects the signal brought by the touch operation, and transmits the signal to the touch controller; The touch controller receives touch information from the touch detection device, converts it into contact coordinates, and then sends it to the processor 1010, and receives the command sent by the processor 1010 and executes it. Moreover, the touch panel 10071 can be realized by various types such as resistive, capacitive, infrared and surface acoustic wave. Moreover to the touch panel 10071, the user input unit 1007 may also include other input devices 10072. Specifically, other input devices 10072 may include, but are not limited to, a physical keyboard, function keys (such as volume control buttons, switch buttons, etc.), a trackball, a mouse, and a joystick, which are not described in detail here.

Further, the touch panel 10071 can be covered on the display panel 10061. When the touch panel 10071 detects a touch operation on or near it, it is transmitted to the processor 1010 to determine the type of touch event, and then the processor 1010 provides corresponding visual output on the display panel 10061 according to the type of touch event. Although in FIG. 10, the touch panel 10071 and the display panel 10061 are two independent components to realize the input and output functions of electronic equipment, in some embodiments, the touch panel 10071 and the display panel 10061 can be integrated to realize the input and output functions of electronic equipment, which is not limited here.

The interface unit 1008 is an interface between an external device and the electronic device 1000. For example, the external device may include a wired or wireless headset port, an external power supply (or battery charger) port, a wired or wireless data port, a memory card port, a port for connecting a device with an identification module, an audio input/output (I/O) port, a video I/O port, an earphone port, and the like. The interface unit 1008 may be used to receive input (e.g., data information, power, etc.) from an external device and transmit the received input to one or more elements within the electronic device 1000 or may be used to transmit data between the electronic device 1000 and the external device.

The memory 1009 can be used to store software programs and various data. The memory 1009 may mainly include a storage program area and a storage data area, wherein the storage program area may store an operating system, application programs required by at least one function (such as sound playing function, image playing function, etc.), etc. The data storage area can store data (such as audio data, phone book, etc.) created according to the use of the mobile phone. Moreover, the memory 1009 may include a high-speed random access memory, and may also include a non-transitory memory, such as at least one disk memory device, a flash memory device, or other volatile solid-state memory devices.

The processor 1010 is the control center of electronic equipment, which connects all parts of the whole electronic equipment with various interfaces and lines, and performs various functions and processes data of the electronic equipment by running or executing software programs and/or modules stored in the memory 1009 and calling data stored in the memory 1009, thus monitoring the electronic equipment as a whole. The processor 1010 may include one or more processing units; In some embodiments of the present invention, the processor 1010 may integrate an application processor and a modem processor, wherein the present disclosure processor mainly handles the operating system, user interface and application programs, and the modem processor mainly handles wireless communication. It can be understood that the above modem processor may not be integrated into the processor 1010.

The electronic device 1000 may also include a power supply 1011 (such as a battery) for supplying power to various components. In some embodiments of the present invention, the power supply 1011 may be logically connected with the processor 1010 through a power management system, so that the functions of managing charging, discharging and power consumption management can be realized through the power management system.

Moreover, the electronic device 1000 includes some functional modules not shown, which are not described in detail here.

It should be noted that in this paper, the terms “including”, “containing” or any other variation thereof are intended to cover non-exclusive inclusion, so that a process, method, article or device including a series of elements includes not only those elements, but also other elements not explicitly listed, or elements inherent to such process, method, article or device. Without more restrictions, an element defined by the phrase “including one” does not exclude the existence of other identical elements in the process, method, article or device including the element.

Through the description of the above embodiments, those skilled in the art can clearly understand that the methods of the above embodiments can be realized by means of software and necessary general hardware platform, and of course they can also be realized by hardware, but in many cases, the former is the better embodiment. Based on this understanding, the technical scheme of the present disclosure can be embodied in the form of a software product, which is stored in a storage medium (such as ROM/RAM, magnetic disk, optical disk) and includes several instructions to make a terminal (which can be a mobile phone, a computer, a server, an air conditioner, or a network device, etc.) execute the methods of various embodiments of the present disclosure.

The embodiments of the present disclosure have been described above with the attached drawings, but the present disclosure is not limited to the above specific embodiments, which are only schematic, not restrictive. Under the inspiration of the present disclosure, those skilled in this field can make many forms without departing from the purpose of the present disclosure and the scope protected by the claims, which are all within the protection of the present disclosure.

Those skilled in the art can realize that the units and algorithm steps of various examples described in connection with the embodiments disclosed in the embodiments of the present disclosure can be realized by electronic hardware, or a combination of computer software and electronic hardware. Whether these functions are implemented in hardware or software depends on the specific application and design constraints of the technical scheme. Those skilled in the art can use different methods to realize the described functions for each specific application, but this implementation should not be considered beyond the scope of the present disclosure.

It can be clearly understood by those skilled in the art that for the convenience and conciseness of description, the specific working processes of the systems, devices and units described above can refer to the corresponding processes in the aforementioned method embodiments, and will not be repeated here.

In the embodiments provided by the present disclosure, it should be understood that the disclosed devices and methods can be realized in other ways. For example, the device embodiment described above is only schematic. For example, the division of units is only a logical function division. In actual implementation, there may be other division methods, such as a plurality of units or components can be combined or integrated into another system, or some features can be ignored or not implemented. On the other hand, the mutual coupling or direct coupling or communication connection shown or discussed can be indirect coupling or communication connection through some interfaces, devices or units, which can be electrical, mechanical or other forms.

The units described as separate components may or may not be physically separated, and the components displayed as units may or may not be physical units, that is, they may be located in one place or distributed to a plurality of network units. Some or all of the units can be selected according to actual needs to achieve the purpose of this embodiment.

Moreover, each functional unit in each embodiment of the present disclosure can be integrated into one processing unit, or each unit can exist physically alone, or two or more units can be integrated into one unit.

Functions can be stored in a computer-readable storage medium if they are realized in the form of software functional units and sold or used as independent products. Based on this understanding, the technical scheme of the present disclosure can be embodied in the form of a software product, which is stored in a storage medium and includes several instructions to make a computer device (which can be a personal computer, a server, a network device, etc.) execute all or part of the steps of the methods of various embodiments of the present disclosure. The aforementioned storage media include: U disk, mobile hard disk, ROM, RAM, magnetic disk or optical disk and other media that can store program codes.

The above is only the specific implementation of the present disclosure, but the protection scope of the present disclosure is not limited to this. Any person skilled in this art can easily think of changes or substitutions within the technical scope disclosed in the present disclosure, which should be covered by the present disclosure. Therefore, the protection scope of the present disclosure should be based on the protection scope of the claims.

1. A GPU (Graphics Processing Unit) computing resource management method, wherein the method is applied to a GPU sharing system, the GPU sharing system is deployed with a Kubernetes cluster, and the Kubernetes cluster comprises a plurality of Node nodes and a plurality of Pod services, wherein each of the Node nodes comprises a plurality of GPUs, and GPU computing resources corresponding to the GPUs at least comprise GPU video memories and GPU computing cores, the method comprising:
dividing the GPU in each of the Node nodes to obtain a plurality of vGPUs (virtual Graphics Processing Unit), wherein, each of the vGPUs comprises a part of the GPU video memories and a part of the GPU computing cores of the GPUs, and one vGPU corresponds to one Pod service;
collecting vGPU information of each of the vGPUs in the Node nodes, and registering each vGPU information to obtain Pod information of each Pod service corresponding to each vGPU;
receiving each Pod information and saving each Pod information as a file respectively; and
managing the part of GPU video memories and the part of GPU computing cores in each vGPU according to each file.

2. The method according to claim 1, wherein dividing the GPU in each of the Node nodes to obtain a plurality of vGPUs comprises:
when dividing the GPU in the Node nodes, allocating the GPU video memories and GPU computing cores of the GPU to each of the vGPUs according to a preset resource quota, so as to obtain a plurality of vGPUs containing the part of GPU video memories and the part of GPU computing cores.

3. The method according to claim 1, wherein the vGPU information at least comprises an amount of the vGPUs and a size of the GPU video memories of the vGPU.

4. The method according to claim 1, wherein the Kubernetes cluster further comprises Master nodes, and the Master nodes comprise hijacking schedulers, the step of collecting vGPU information of each of the vGPUs in the Node nodes, and registering each vGPU information to obtain Pod information of each Pod service corresponding to each vGPU comprises:
collecting vGPU information of each of the vGPUs in the Node nodes;
sending each vGPU information to the hijacking schedulers in the Master nodes, and registering each vGPU information to obtain Pod information of each Pod service corresponding to each vGPU.

5. The method according to claim 4, wherein receiving each Pod information and saving each Pod information as a file respectively comprises:
receiving the Pod information of each Pod service corresponding to each vGPU returned by the hijacking scheduler, and saving each Pod information as a file respectively.

6. The method according to claim 4, wherein the Pod information at least comprises a usage of the GPU video memories and a usage of the GPU computing cores in the vGPU.

7. The method according to claim 6, wherein managing the part of GPU video memories and the part of GPU computing cores in each vGPU according to each file comprises:
saving the usage of the GPU video memories and the usage of the GPU computing cores corresponding to vGPUs in the Pod information as the files;
controlling a process of the Pod service according to the usage of the GPU video memories and the usage of the GPU computing cores corresponding to vGPUs in the files.

8. The method according to claim 7, wherein controlling a process of the Pod service according to the usage of the GPU video memories and the usage of the GPU computing cores corresponding to vGPUs in the files comprises:
if the usage of the GPU video memories and the usage of the GPU computing cores corresponding to vGPUs in the files computing cores exceed preset resource quotas, controlling the GPU video memories and the GPU computing cores in the vGPU to terminate the process of the Pod service;
if the usage of the GPU video memories and the usage of the GPU computing cores corresponding to vGPUs in the files meet the preset resource quotas, the process of the Pod service running normally.

9. The method according to claim 1, wherein the method further comprises:
expanding and contracting an amount of the Pod services according to the usage of the GPU video memories and the usage of the GPU computing cores in each vGPU contracted.

10. The method according to claim 9, wherein the GPU is located on a host computer, and the host computer at least comprises a CPU and a memory, and the Pod service is bound with the CPU and the memory, and expanding and contracting an amount of the Pod services according to the usage of the GPU video memories and the usage of the GPU computing cores in each vGPU comprises:
acquiring a CPU utilization rate corresponding to the CPU and an average memory utilization rate corresponding to the memory in the host computer;
automatically expanding and contracting the amount of the Pod services according to the CPU utilization rate and the average memory utilization rate.

11. The method according to claim 10, wherein automatically expanding and contracting the amount of the Pod services according to the CPU utilization rate and the average memory utilization rate comprises:
if the CPU utilization rate and/or the average memory utilization rate corresponding to the Pod services are lower than a preset utilization rate, automatically contracting the amount of the Pod services to contract the amount of the vGPUs corresponding to the Pod services;
if the CPU utilization rate and/or the average memory utilization rate corresponding to the Pod services are higher than the preset utilization rate, automatically expanding the amount of the Pod services to expand the amount of the vGPUs corresponding to the Pod services.

12. The method according to claim 9, wherein expanding and contracting an amount of the Pod services according to the usage of the GPU video memories and the usage of the GPU computing cores in each vGPU comprises:
acquiring a real-time service request flow of the Pod services;
automatically expanding and contracting the amount of the Pod services according to the real-time service request flow of the Pod services.

13. The method according to claim 12, wherein automatically expanding and contracting the amount of the Pod services according to the real-time service request flow of the Pod services comprises:
if the real-time service request flow of the Pod services is greater than a preset real-time service request flow, automatically expanding the amount of the Pod services to expand the amount of the vGPUs corresponding to the Pod services;
if the real-time service request flow of the Pod services is less than the preset real-time service request flow, automatically contracting the amount of the Pod services to contract the amount of the vGPUs corresponding to the Pod services.

14. The method according to claim 9, wherein the method further comprises:
when an amount of the automatically expanded and contracted Pod services meets the preset resource quota of the Pod services, scheduling the Pod services to a target GPU.

15. The method according to claim 1, wherein the Kubernetes cluster further comprises Master nodes, and the Master nodes comprise controllers, and the controllers are configured to create resources corresponding to different types of the Pod services.

16. The method according to claim 15, wherein the resources at least comprise a deployment, a service and a statefulset.

17. The method according to claim 16, wherein the deployment is configured to deploy stateless Pod services, the service is configured to deploy Pod service that may scale to zero, and the statefulset is configured to deploy stateful Pod services.

18. (canceled)

19. An electronic device comprising a processor, a communication interface, a memory and a communication bus, wherein the processor, the communication interface and the memory communicate with each other through the communication bus;
the memory is configured to store computer programs;
the processor is configured to implement the method according to claim 1 when executing the programs stored in the memory.

20. A non-transitory readable storage medium on which instructions are stored, which, when executed by one or more processors, cause the processors to perform the method according to claim 1.

21. The method according to claim 10, wherein the method further comprises:
when an amount of the automatically expanded and contracted Pod services meets the preset resource quota of the Pod services, scheduling the Pod services to a target GPU.
